(19) United States
(12) Patent Application Publication
(10) Pub. No.: US 2006/0033387 A1
(43) Pub. Date: Feb. 16, 2006

(54) Control device

(76) Inventor: Philippa C Wagner, London (GB)

Correspondence Address: PHILIPS INTELLECTUAL PROPERTY & STANDARDS, P.O. BOX 3001, BRIARCLIFF MANOR, NY, 10510, US

(21) Appl. No.: 10/519,056

(22) PCT Filed: Jun. 13, 2003
(86) PCT No.: PCT/IB03/03003

§ 371 Date: Dec. 22, 2004

(30) Foreign Application Priority Data
Jun. 29, 2002 (GB) 0215132.2

(51) Int. Cl. H02K 33/00

(52) U.S. Cl. 310/15

(57) ABSTRACT

An electrical control device includes a knitted fabric 11 having a knitted guide portion 12 for accommodating and guiding a cord 41 that may be pulled by its ends to move the cord along the guide portion. Conductive knitted tracking 15 communicates with conductive portions 16 of the guide portion. The cord includes electrically conductive portion 41 which is able to communicate selectively with portions 16. As shown, conductive cord portion 41 is in electrical contact with conductive portions 16a and 16b, thereby serving to provide electrical continuity between fabric tracking 15a and 15b. By sliding the cord along the guide, conductive portion 41a may be moved to communicate simultaneously with portions 16b and 16c, thereby establishing electrical communication with tracking 15b and 15c. Thus, a two way electrical switch is provided.

The present invention relates to a sliding control device that is particularly, but not exclusively, suitable for use within flexible articles such as apparel and soft furnishings.

The task of integrating or fitting electrical and electronic apparatus within clothing or other soft items presents a number of problems to the designer. The incorporation of control devices, such as switches is no exception.

One approach to integrating electrical control devices or components into clothing is to use standard “off the shelf” electronic components that are then sewn, glued or otherwise mounted to clothing. Unfortunately this approach has a number of disadvantages arising from the fact that these components are primarily intended for use in conventional electronic equipment. However, in the case of clothing and furnishing which is normally manufactured from flexible textile material, even if the conventional control components are successfully attached, the mounting achieved will not always be rigid making operation of the control device by a user difficult. Another disadvantage of this approach is that clothing or other items provided with these components has the feel and appearance of clothing or furnishing with components stuck on top, rather than the components being neatly integrated and in keeping with the character of the items to which they are attached.

This latter point is important because a primary consideration when selecting a garment or article of furnishing is its appearance. The inclusion of a control device that detracts from the appeal of clothing or other article is most undesirable from the point of view of the designer and consumer. User controls for use in clothing or furnishing that are to be visible should look right, whether they are incorporated as a prominent design feature, as a discrete implementation or even disguised. In many cases there is a requirement for the component to have a degree of mechanical flexibility so that it is able to conform to some extent to the shape of the article to which it is applied or integrated. In the cases where the article is flexible, it is usually desirable that the component is able to flex with that article. Traditional electronic components do not always meet this requirement.

The use of such conventional components also causes problems to manufacturers because the machines and processes commonly used within the garment or furniture construction industry will not be designed for connecting the components to fabrics, either in terms of providing a physical mounting for the components or making the electrical connections thereto.

WO-A-01/63630 describes a sliding electrical switch for use in a garment. The switch includes two spaced elongate flexible surfaces, at least one electrical contact on each surface, and a slider that is slidable along the surfaces to cause electrical connection between the contacts. There may be a number of contacts, wherein the slider acts as a selection switch otherwise there may be two continuous spaced contacts wherein movement of the slider provides a variation in resistance. These switch arrangements require that the user has access to all regions of the switch flexible surfaces for which the slider can be positioned, so unless the switch is concealed in an accessible location, for example in a pocket, the switch will generally assume a prominent elongate external design feature of an article. In some cases, such feature may be undesirable or difficult to accommodate due to space requirements.

It is an object of the present invention to provide an improved sliding control device suitable for use in clothing, soft furnishings and the like which seeks to address, at least in part, one or more of the above mentioned problems.

In accordance with a first aspect of the present invention there is provided a sliding control device comprising a guide section and a cord extending through said guide section and slidable within said guide section, said guide section having an associated first electrical component and said cord having a second electrical component, wherein said cord is slidable along said guide section to move said second electrical component with respect to said first electrical component thereby produce an electrical control action.

Typically, the cord extends at each of its ends beyond the guide section allowing a user to grasp and pull each cord end and so move the cord in sliding manner with respect to the guide section.

Optionally, said first electrical component is an electrically conductive element arranged to form a first switch contact and said second electrical component is an electrically conductive element arranged to form a second switch contact, the electrical control action being produced by sliding said cord in a first direction to move said second switch contact into electrical contact with said first switch contact. In this case the first and second switch contact may be moved out of electrical contact with each other by sliding said cord in a second, reverse direction or otherwise continuing to slide the cable in the first, forward direction.

The first and second switch contacts may make physical and electrical connections with each other. The guide section may be of knitted or woven construction.

By appropriate choice of materials, it is possible to provide a control device that is made entirely of soft materials. In the case of use of such device in a garment, this minimises any discomfort to a wearer that may be brought about by incorporation of the control device.

These and other aspects of the present invention appear in the appended claims to which the reader is now referred and which are incorporated herein by reference.

The present invention will now be described, by way of example only, with reference to the Figures of the accompanying drawings wherein:

FIG. 1 shows a plan view of part of a first embodiment of a control device made in accordance with the present invention;

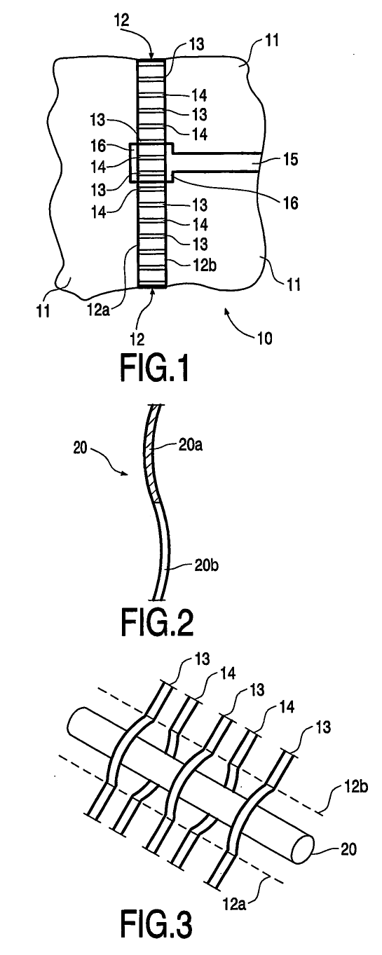

FIG. 2 shows a plan view of part of a first embodiment of a control device made in accordance with the present invention;

FIG. 3 shows a portion of the first embodiment in detail;

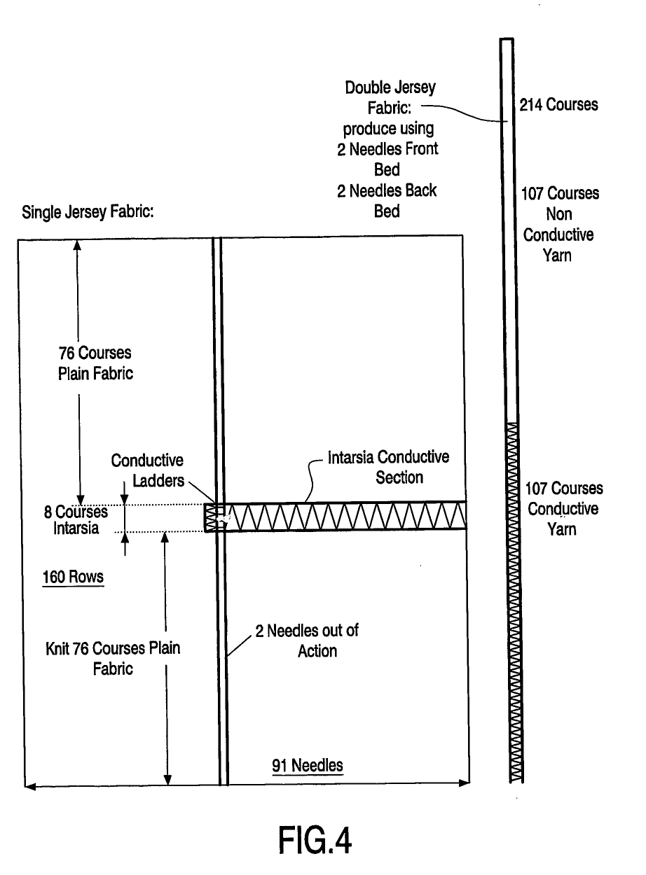

FIG. 4 shows diagrammatically knitting instructions to produce the first embodiment;

FIG. 5 shows a plan view of a second embodiment of a control device made in accordance with the present invention;

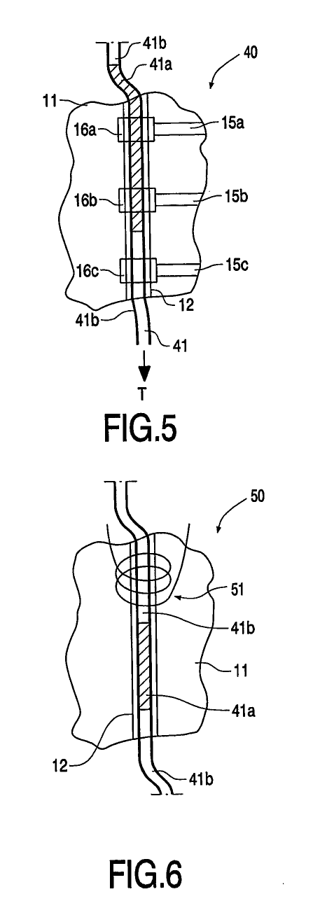

FIG. 6 shows a plan view of a third embodiment of a control device made in accordance with the present invention; and

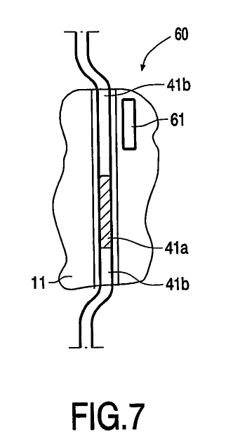

FIG. 7 shows a plan view of a fourth embodiment of a control device made in accordance with the present invention.

It should be noted that the drawings are diagrammatic and not drawn to scale. Relative dimensions and proportions of parts of the Figures have been shown exaggerated or reduced in size for the sake of clarity and convenience in the drawings. The same reference signs are generally used to refer to corresponding or similar features in the different embodiments.

With reference to FIGS. 1, 2 and 3, a first embodiment of a control device of the present invention is shown in the form of a switch 10. Switch 10 is constructed in part from a single bed knitted fabric 11. The fabric 11 is generally made of electrically insulative material and is knitted to also provide a device guide section or portion 12. To form the device guide portion 12, the yarn making up the fabric 11 is not knitted in the vicinity of the guide portion 12; rather the yarn merely spans from a first side of the guide portion 12a to a second side of the guide portion 12b. Some of these spanning yarns are illustrated for clarity and are denoted by reference numeral 13 and 14 alternately.

The knitted fabric also includes a region of conductive tracking 15 formed by including conductive yarns extending to a region 16 of the guide portion 12. Region 16 provides the device associated first electrical component. At reaching region 16 of guide portion 12, the conductive yarns of the tracking continue within region 16 to form an integral part of the guide portion; that is, within region 16 the conductive yarns span from a first side of the guide portion 12a to a second side of the guide portion 12b.

A cord 20 is provided with a first section 20a that is electrically conductive and a second section 20b that is electrically insulative. The electrically conductive section 20a provides the device second electrical component.

To complete the switch arrangement of the first embodiment, the cord 20 is fed into the guide portion 12 by passing the cord under a first spanning yarn 13, over a subsequent spanning yarn 14, under a following spanning yarn 13, over a subsequent spanning yarn 14 and so on, such that the cord is guided along and at least partially accommodated within the guide portion 12 by virtue of alternately weaving the cord 20 under and over spanning yarns 13, 14 as the guide portion is traversed. This is shown in detail in FIG. 3. Although the pattern of alternately passing the cord 20 over and under each consecutive spanning yarn sequentially is described, other arrangements or sequences could be used as preferred, as will be appreciated by the person skilled in the art.

Thus, the guide portion 12 is able to perform the function of accommodating and guiding a cord 20 or the like, and furthermore permitting the cord to slide lengthwise along the guide portion.

During use, the cord 20 is at least partially accommodated within guide portion 12 and the cord extends beyond the extent of the guide portion to thus be accessible at each end and so can be grasped by a user. By grasping and pulling an end of the cord, it is possible to slide the cord along the guide portion 12 in a first direction. Similarly, by grasping and pulling another end of the cord, it is possible to slide the cord along the guide portion 12 in a second direction opposite to the first direction.

By pulling the cord to bring at least part of the conductive section 20a of the cord into the region 16 of the guide, the conductive section 20a of the cord establishes electrical connection with conductive yarn within region 16 of the guide portion 12. Thus, electrically conductive portion 20a of the cord establishes electrical connection with conductive tracking 15. Similarly the cord may be moved to remove conductive section 20a of the cord from the conductive region 16 and so break the electrical connection between the conductive portion 20a of the cord and the tracking 15.

In order to connect this switch in an electrical circuit for use, a first switch terminal is provided in the form of conductive tracking 15 and a second switch terminal is provided in the form of cable conductive portion 20a.

To produce the switch 10, the single plain (jersey) knitting technique is used for form fabric 11. The guide portion 12 is produced during knitting by taking knitting needles out of action, and where these needles are out of action the knitting process does not create a knit but instead creates a ladder of spanning yarns 13, 14 in the knitted fabric, the spanning yarns 13, 14 forming the guide portion 12. The region of conductive tracking 15 is also produced during knitting and is provided by performing an intarsia knitting operation using at least a proportion of electrically conductive yarn to form tracking 15 in the regions required.

In one specific example of switch 10, a knitting bed is set up using 91 needles. Two of these needles are taken out of action to form the guide portion 12 in the location required. First, 76 courses of plain knit are produced using electrically insulative yarn across the width of the bed (with the exception of the regions where the needles have been taken out of action). Second, for the next 8 courses an intarsia knit is performed using at least a proportion of electrically conductive yarn, across a consecutive number of needles (but not necessarily all needles across the whole width of the bed) to form the tracking 15. The intarsia knit extends into the vicinity of the guide portion 16 and here the conductive yarn of the intarsia knit is used to create spanning yarn across guide portion 12 between 12a and 12b in a similar manner to spanning yarns 13 and 14. For the same 8 courses, for those regions where conductive tracking is not required, a plain knit using insulative yarn is used such that the knit continues seamlessly from the first 76 courses. Third, a further 76 courses of plain knit are produced using electrically insulative yarn across the width of the bed. This is illustrated diagrammatically in FIG. 4.

The cord 20 is produced by knitting it as a double jersey fabric (two needles front, two needles back), with the first electrically conductive section 20a made up of 107 courses which include at least a proportion of electrically conductive yarn. The second electrically conductive section 20b is made up of 107 courses of electrically insulative yarn. This is illustrated diagrammatically in FIG. 4.

Optionally tubing (not shown) may be accommodated in the guide section 20 and the cord then fed through the tubing section. Where the tubing is an electrical insulator, this can serve to provide additional insulation for the cord. The tubing needs to be either discontinuous or otherwise electrically conductive in regions 16. The tubing is knitted separately on a double bed hand flat knitting machine by alternately knitting front then back beds with the same yarn. The tubes are sewn into the switch 10.

In a second embodiment of the present invention, a switch 40 performs 2-way electrical switching operation. As in the case of the first embodiment, the switch is made from a single bed knitted fabric 11. The fabric 11 is generally made of electrically insulative material and comprises a guide portion 12. In this embodiment the woven fabric comprises three regions of electrically conductive tracking 15a, 15b, 15c, each extending to intersect and make electrical contact with the device guide portion 12 at regions 16a, 16b and 16c respectively. Each region of conductive tracking 15a, 15b and 15c can be used as a switch terminal.

In this second embodiment the cord 41 is made of three portions, two electrically insulative end most portions 41b and an electrically conductive central portion 41a. For clarity, the conductive portion 41a is shaded in the Figures. With the cord arranged as shown in FIG. 5, the electrically conductive portion 41a of the cord 41 extends between and makes electrical contact with regions 16a and 16b and so provides electrical continuity between conductive tracking 15a and 15b. However, the cord may be grabbed by its end and pulled by a user in the direction denoted ‘T’ and so slide the cord along the guide portion 12 such that the conductive portion extends between and establishes electrical contact with regions 16b and 16c (not 16a) and so provides electrical continuity between conductive tracking 15b and 15c.

Other switch arrangements could be produced, as will be appreciated by the person skilled in the art. Variations would include the number and spacing of regions 16, number and spacing of conductive tracks 15 and the length of the conductive portion 41a of the cord 41. Indeed, the device could be arranged so that the electrically conductive portion 41a of the cord is able to establish electrical contact with two or more electrical contact regions 16a, 16b, 16c simultaneously. In one example, moving the cord in a particular direction causes the conductive portion 41a to make contact with an increasing number of electrical contact portions 16 simultaneously.

It is not essential that electrical contact is made between conductive elements of the cord and guide. With reference to FIG. 6 a control device of the present invention is provided with a device first electrical component in the form of an inductive coil 51 arranged around an upper region of the guide portion. When the cord 41 is moved to bring electrically conductive region 41a near to or within the part of the guide portion 12 surrounded by the inductive coil 51, electrical characteristics of the inductive coil 51 can be altered and by measuring the characteristics, switch operation can be determined.

With reference to FIG. 7, the device associated first electrical component can be provided in the form of an electrical component 61 placed adjacent to, rather than surrounding, the guide 12 and still whilst facilitating detection of whether the conductive region 41a of the cord is nearby or adjacent to the electrical component 61. Such components 61 can include inductive coils, reed switches, proximity detectors, hall effect detectors, capacitive detectors or any other suitable detector as will be appreciated by the person skilled in the art. The component 61 will require one or more electrical connections to be made thereto, and the electrical connections may be provided using conventional electrical wiring or conductive tracking similar in construction to conductive tracking 15. Alternatively the component may be capable of establishing wireless communication (for example by a radio frequency communication) in which case it may be possible to dispense with the need to make one or more electrical connection thereto, as will be appreciated by the person skilled in the art.

In the case of producing devices in accordance with the present invention, any suitable yarns may be used, as will be appreciated by the person skilled in the art. For example, in the case of electrically insulative yarns, some preferred materials include nylon, cotton, polyester or wool. In the case of electrically conductive yarns, suitable materials include, stainless steel yarns, silver plated yarns, yarn including conductive polymers or any inherently conductive yarn that is spun to specification for knitting. Conductive and insulative yarns may be made of one type of material or a combination of materials.

While specific knit types have been discussed, other suitable knit types could be used instead. Furthermore, while a knitted construction has been described, it is also possible to produce devices of the present invention using weaving or embroidering techniques. Each of these techniques will still have conductive and non conductive areas. For a woven construction Jacquard would be an appropriate process and for the ladder area (i.e. forming the guide section) warp threads would be left out of the reed and in an embroidered version a ladder stitch would be used to create the conductive ladder area, and fabric manipulation such as laser cutting could be used to create the ladder area. The wires would be embroidered onto a base insulating fabric using conductive embroidery threads. A device using a combination of knitted, woven or embroidered constructions may be realised, as will be appreciated by the person skilled in the art.

Indeed, control devices can be designed that give an on/off type switching action or a variable control action, as may be suited for operating radio tuning or volume level for example. The conductive region 20a or 41a of the cord could be produced such that resistivity varies along the length of section 41a, say in a linear or logarithmic manner. The cord may include ferrous or non ferrous material that may be sealed in plastic or the like so that it may be washed without encouraging oxidation, yet serve to have an effect when brought into the proximity of the device first electrical component.

Uses of the control device in wearable electronics clothing include control functions such as to control radio tuning, volume and lighting in garments. In the case of furnishings, it would be possible to use the control device to control items in the room such as lights, audio-visual equipment and other electrical or electronic equipment.

From reading the present disclosure, other modifications will be apparent to persons skilled in the art. Such modifications may involve other features which are already now in the design manufacture and use of textile articles such as garments, clothing accessories, wearable computer arrangements and applications thereof, and which may be used instead of or in addition to features already described herein.

1. A sliding control device (10, 40, 50) comprising a guide section (12) and a cord (20, 41) extending through said guide section and slidable within said guide section, said guide section having an associated first electrical component (16, 16a, 16b, 16c, 51, 61) and said cord having a second electrical component (20a, 41a), wherein said cord is slidable along said guide section to move said second electrical component to with respect to said first electrical component to thereby produce an electrical control action.

2. A device in accordance with claim 1, wherein said first electrical component is an electrically conductive element (16, 16a) arranged to form a first switch contact and said second electrical component is an electrically conductive element (20a, 41a) arranged to form a second switch contact, the electrical control action being produced by sliding said cord in a first direction to move said second switch contact into electrical contact with said first switch contact.

3. A device in accordance with claim 2, wherein said electrical contact is established by virtue of said first and second switch contact making physical and electrical connection with each other.

4. A device in accordance with claim 2 or 3, wherein said guide section includes a further first electrical component (16b, 16c) in the form of an electrically conductive element, said further first electrical component being arranged at said guide section such that said second switch contact (20a, 41a) is movable to establish electrical contact with each first electrical component simultaneously.

5. A device in accordance with claim 1 wherein said associated first electrical component is an inductive coil (51).

6. A device in accordance with any one or more of claims 1 to 5 wherein at least one said first electrical component (16, 16a, 16b, 16c) forms part of said guide section.

7. A device in accordance with claim 6 wherein said guide section (12) is of knitted, woven or embroidered construction.

8. A device in accordance with any one or more of claims 1 to 7 wherein said guide section (12) is an integral part of a fabric component (11).

9. A textile article including a sliding control device (10, 40, 50) having the technical features of any one or more of claims 1 to 8.

10. A cord comprising the technical features of the cord of any one of claims 1 to 8.
